(19) United States
(12) Patent Application Publication
(10) Pub. No.: US 2013/0108954 A1
(43) Pub. Date: May 2, 2013

(54) TONER

(71) Applicant: Canon Kabushiki Kaisha, Tokyo (JP)

(72) Inventors: Daisuke Tsujimoto, Suntou-gun (JP); Katsuhisa Yamazaki, Numazu-shi (JP); Toru Takahashi, Mishima-shi (JP); Yosuke Iwasaki, Suntou-gun (JP); Shuhei Moribe, Mishima-shi (JP); Masami Fujimoto, Suntou-gun (JP)

(73) Assignee: CANON KABUSHIKI KAISHA, Tokyo (JP)

(21) Appl. No.: 13/663,238

(22) Filed: Oct. 29, 2012

(30) Foreign Application Priority Data
Nov. 2, 2011 (JP) 2011-241440

(51) Int. Cl. G03G 9/087

(52) U.S. Cl. 430/109.3

(57) ABSTRACT

A toner contains a hybrid resin. When the hybrid resin is dissolved in tetrahydrofuran at 25.0° C., tetrahydrofuran-soluble matter has a glass transition temperature TgB of from 30.0° C. to 50.0° C. When the hybrid resin is dissolved in cyclohexane at 25.0° C., cyclohexane-soluble matter has a glass transition temperature TgA (° C.) higher than the glass transition temperature TgB, and in differential scanning calorimetry, cyclohexane-insoluble matter shows a differential scanning calorimetry curve having an endothermic peak whose peak top falls within the range from 60.0° C. to 110.0° C.

### BACKGROUND OF THE INVENTION

1. Field of the Invention

The present invention relates to toners for use in electrophotography, methods for forming images by developing electrostatic images, and toner jet printing.

2. Description of the Related Art

There has been a growing need for electrophotographic image output apparatuses, such as copiers and printers, with improved print image quality and improved energy efficiency due to reduced fusing temperatures. The development of high-speed, long-life copiers and printers has also led to a need for toners with reduced melting temperatures and improved long-term storage stability and durability.

One known technique for quickly melting a toner is to control the melting properties of a binder resin, which is a major component of a toner. Controlling the melting properties of the binder resin itself, however, significantly affects the durability and the storage stability. Another technique is to control the melting properties of the binder resin by a plasticization effect using a fusing aid (i.e., an additive such as a low-melting-point wax or crystalline polyester). It is difficult, however, to control the plasticization effect of the fusing aid for improved low-temperature fusibility, and the durability and the storage stability decrease. To overcome this problem, the following techniques have been suggested.

Japanese Patent Laid-Open No. 2007-58135 discloses a toner binder resin containing a low-melting-point polyester resin formed by condensation polymerization of starting monomers including a monovalent long-chain aliphatic compound. The monovalent long-chain aliphatic compound attached to the polyester allows plasticization of the binder resin. However, there is room for improvement in the plasticization of the binder resin because it has an insufficient amount of long-chain aliphatic compound introduced in the polyester. Reducing the molecular weight of the polyester or increasing the content of the long-chain aliphatic compound for improved low-temperature fusibility would significantly decrease the melting properties of the resin itself and thus degrade the long-term storage stability and the durability.

International Publication No. WO08/044726 discloses a toner containing a binder resin that is a hybrid resin having a long-chain alkyl monomer attached to polyester ends therein. Again, there is room for improvement in the plasticization of the binder resin because the hybrid resin has an insufficient amount of long-chain alkyl monomer introduced in the polyester resin. In addition, while the plasticity is improved, it is difficult to ensure sufficient durability and storage stability at the same time.

Japanese Patent Laid-Open No. 2010-175734 discloses a toner prepared by emulsion aggregation using a block polyester containing crystalline polyester and amorphous polyester as a binder resin to form portions with different melt viscosities in the toner, thereby providing a good balance of fusibility and durability. It is difficult, however, to control phase dissolution and separation of the crystalline polyester and the amorphous polyester in the binder resin for improved low-temperature fusibility. In addition, the use of a crystalline material for quickly melting the toner tends to significantly decrease the melting properties of the toner and degrade the storage stability.

As discussed above, there is still a problem in providing a good balance of low-temperature fusibility and storage stability and durability.

### SUMMARY OF THE INVENTION

The present invention is directed to providing a toner that has superior low-temperature fusibility and superior storage stability and durability and that can provide a sharp image over an extended period of time.

According to one aspect of the present invention, there is provided a toner including toner particles each of which contains a binder resin and a colorant. The binder resin is a hybrid resin in which a polyester unit and a vinyl polymer unit are chemically bound, and the hybrid resin satisfies the following:

(I) when the hybrid resin is dissolved in tetrahydrofuran at 25.0° C., tetrahydrofuran-soluble matter has a glass transition temperature TgB of from 30.0° C. to 50.0° C.; and

(II) when the hybrid resin is dissolved in cyclohexane at 25.0° C.,
(i) cyclohexane-soluble matter has a glass transition temperature TgA (° C.) higher than the glass transition temperature TgB, and
(ii) in differential scanning calorimetry, cyclohexane-insoluble matter shows a differential scanning calorimetry curve having an endothermic peak whose peak top falls within the range from 60.0° C. to 110.0° C.

The toner according to the above aspect of the present invention has superior low-temperature fusibility and superior storage stability and durability and can provide a sharp image over an extended period of time.

Further features of the present invention will become apparent from the following description of exemplary embodiments.

### DESCRIPTION OF THE EMBODIMENTS

To solve the above problem, the inventors have focused on a hybrid resin in which a polyester unit and a vinyl polymer unit are chemically bound. This hybrid resin contains the polyester unit, which is advantageous for fusibility, and the vinyl polymer unit, which is advantageous for developability and durability, thus providing a wide range of resin designs. With this feature, the melting properties of the polyester unit can be controlled for improved low-temperature fusibility. At the same time, the structure of the vinyl polymer unit can be controlled to maintain the storage stability and durability of a toner. After a considerable study on this point, the inventors have found that the use of a hybrid resin having the following properties as a binder resin for toners solves the above problem.

When a hybrid resin according to an embodiment of the present invention is dissolved in tetrahydrofuran (THF) at 25.0° C., the THF-soluble matter has a glass transition temperature TgB of from 30.0° C. to 50.0° C. When the hybrid resin according to this embodiment is dissolved in cyclohexane at 25.0° C., the cyclohexane-soluble matter has a glass transition temperature TgA (° C.) higher than the glass transition temperature TgB.

Cyclohexane, which is a nonpolar solvent, poorly dissolves polyester because it has high polarity, and readily dissolves vinyl resin because it has low polarity. The cyclohexane-soluble matter, therefore, is rich in the vinyl polymer unit. That is, TgA is indicative of the glass transition temperature of the component derived from the vinyl polymer unit in the hybrid resin. Conversely, THF, which has moderate polarity, can dissolve both polyester and vinyl resin. TgB, therefore, which is the glass transition temperature of the THF-soluble matter, is indicative of the glass transition temperature of the entire hybrid resin.

If TgA is higher than TgB, the glass transition temperature of the component rich in the vinyl polymer unit in the binder resin is higher than the glass transition temperature of the entire hybrid resin, i.e., the vinyl polymer unit has a higher rigidity and viscosity than the polyester unit. This allows the component derived from the vinyl polymer unit in the hybrid resin to maintain superior storage stability and durability of the toner.

If TgA is lower than or equal to TgB, the rigidity and viscosity of the vinyl polymer unit are lower than or equal to those of the entire hybrid resin. This impairs the low-temperature fusibility because the polyester unit, which is intended to improve the fusibility, has a higher melt viscosity for improved storage stability and durability of the toner. The temperature difference between TgA and TgB (TgA−TgB) is preferably 1.0° C. or more, more preferably 5.0° C. or more, and most preferably from 5.0° C. to 25.0° C.

TgB is from 30.0° C. to 50.0° C., which provides superior storage stability and low-temperature fusibility of the toner. TgB is indicative of the mobility of the entire hybrid resin against temperature changes. If TgB is lower than 30.0° C., the entire hybrid resin has extremely high mobility at room temperature, thus decreasing the storage stability of the toner. If TgB is higher than 50.0° C., the entire hybrid resin has extremely low mobility, thus decreasing the low-temperature fusibility of the toner. Preferably, TgB is from 35.0° C. to 45.0° C.

The hybrid resin according to this embodiment contains cyclohexane-insoluble matter that does not dissolve when the hybrid resin is dissolved in cyclohexane at 25.0° C. In differential scanning calorimetry (DSC), the cyclohexane-insoluble matter shows a DSC curve having an endothermic peak whose peak top falls within the range from 60.0° C. to 110.0° C. The fact that the cyclohexane-insoluble matter has an endothermic peak whose peak top falls within the above range indicates the presence of a portion that melts in the particular temperature range in the molecule of the hybrid resin. This portion facilitates melting of the hybrid resin in the particular temperature range, thus improving the low-temperature fusibility of the toner.

For the hybrid resin according to this embodiment, as described above, TgA is higher than TgB. If the portion that melts in the particular temperature range was bound to the vinyl polymer unit, TgA, which is indicative of the glass transition temperature of the component rich in the vinyl polymer unit, would be lower than TgB. This suggests that the hybrid resin according to this embodiment has the portion that melts in the particular temperature range in the polyester unit thereof.

Introducing the portion that melts in the particular temperature range into the polyester unit of the hybrid resin while controlling the structure of the vinyl polymer unit allows a portion that improves the fusibility and a portion that maintains the rigidity and viscosity of the resin to coexist separately in a single resin. The use of such a hybrid resin for a toner provides a higher level of balance of low-temperature fusibility and storage stability and durability, which are believed to be incompatible with each other, than in the related art.

Another approach might be to introduce the portion that melts in the particular temperature range into the vinyl polymer unit of the hybrid resin while controlling the backbone structure of the polyester unit to maintain the durability and storage stability. This approach, however, is disadvantageous for providing a good balance of low-temperature fusibility and storage stability and durability. Because the vinyl polymer unit is formed by addition polymerization, the monomers thereof tend to be randomly bound, which makes it difficult to uniformly distribute the portion that melts in the particular temperature range over the resin.

In DSC, the hybrid resin according to this embodiment can show a DSC curve having an endothermic peak at which the amount of heat absorbed is from 0.20 to 7.00 J/g. If the amount of heat absorbed at the endothermic peak falls within the above range, a good balance of low-temperature fusibility and storage stability and durability are more easily provided.

The content of the cyclohexane-insoluble matter, which does not dissolve when the hybrid resin according to this embodiment is dissolved in cyclohexane at 25.0° C., can be from 75.0% to 98.0% by mass of the hybrid resin. If the content of the cyclohexane-insoluble matter falls within the above range, the dispersibility of the components other than the binder resin in the toner (e.g., a charge control agent and colorant) and the long-term durability are further improved.

The content of the THF-soluble matter, which dissolves when the hybrid resin according to this embodiment is dissolved in THF at 25.0° C., can be from 3.0% to 40.0% by mass of the hybrid resin. If the content of the THF-soluble matter falls within the above range, the fusibility of the toner is further improved.

The mass ratio of the polyester unit to the vinyl polymer unit in the hybrid resin according to this embodiment can be from 55:45 to 95:5. If the ratio of the polyester unit to the vinyl polymer unit falls within the above range, a good balance can be provided between the low-temperature fusibility and durability and storage stability of the toner.

The peak molecular weight Mp of the THF-soluble matter in the hybrid resin determined by gel permeation chromatography (GPC) can be from 3,000 to 15,000, and the weight average molecular weight Mw can be from 10,000 to 100,000.

In viscoelastometry, the toner according to this embodiment can have no peak of loss tangent (tans=loss elastic modulus (G″)/storage elastic modulus (G′)) in the range from −50.0° C. to 10.0° C. The presence of a peak in the above range indicates that a substance, such as a wax or long-chain alkyl monomer, that plasticizes the toner is liberated in the toner. The absence of a peak in the above range indicates that a substance such as a wax or long-chain alkyl monomer is more uniformly dispersed in the toner without being liberated. Thus, if the toner has no peak in the above range, the storage stability of the toner in a harsher environment than usual (e.g., at 45.0° C. and 95.0% RH for 30 days) is further improved.

The above hybrid resin can be used as a binder resin alone or in combination with a resin having a different molecular weight. In this case, the content of the hybrid resin according to this embodiment in the entire binder resin can be 50% by mass or more.

The monomers used for the polyester unit in the hybrid resin according to this embodiment will now be described.

The hybrid resin according to this embodiment can have the portion (crystalline portion) that melts in the particular temperature range in the polyester unit thereof. This portion can be introduced by attaching a long-chain fatty acid or long-chain alcohol (hereinafter collectively referred to as “long-chain monomer”) to a branched end of the polyester unit.

The long-chain monomer attached to the end of the polyester unit preferably has from 16 to 102 carbon atoms, more preferably from 25 to 75 carbon atoms. The use of a hybrid resin containing a polyester unit having a long-chain monomer having from 16 to 102 carbon atoms attached thereto provides a partially oriented portion in the toner particles, thus providing superior low-temperature fusibility for the toner.

Examples of long-chain fatty acids include saturated fatty acids such as stearic acid, arachidic acid, cerotinic acid, heptacosanoic acid, montanic acid, melissic acid, lacceric acid, tetracontanoic acid, and pentacontanoic acid; and unsaturated fatty acids such as oleic acid, linoleic acid, and linolenic acid. Examples of long-chain alcohols include saturated alcohols such as octadecyl alcohol, behenyl alcohol, ceryl alcohol, melissyl alcohol, tetracontanol, and pentacontanol; and unsaturated alcohols such as oleyl alcohol and linoleyl alcohol. When attached to the polyester unit, the long-chain monomer is oriented in the binder resin and melts in the particular temperature range, thus improving the low-temperature fusibility of the toner. The content of the long-chain monomer in the polyester monomers is preferably from 0.1 to 20 mol %, more preferably from 1 to 15 mol %, and most preferably from 2 to 10 mol %.

In the manufacture of the hybrid resin, the long-chain alkyl monomer can be added simultaneously with other monomers forming the polyester unit for condensation polymerization. This allows a sufficient amount of long-chain monomer to be introduced into the polyester unit, thus facilitating melting of the binder resin for further improved low-temperature fusibility. The simultaneous addition is also advantageous for eliminating the long-chain monomer that is not attached to the polyester unit. Firmly attaching the long-chain monomer to the polyester unit allows the long-chain monomer to be more uniformly dispersed in the toner particles. This enhances the melting properties of the hybrid resin in the particular temperature range, thus improving the low-temperature fusibility of the toner. If the long-chain monomer is added at the late stage of the polyester condensation reaction, an insufficient amount of long-chain monomer is introduced into the polyester, and some of the long-chain monomer is liberated in the binder resin. This decreases the low-temperature fusibility of the toner.

The long-chain monomer, which has low polarity, is readily soluble in cyclohexane. If some of the long-chain monomer is liberated without being attached to the polyester unit, the DSC curve has no peak in the above temperature range because no long-chain monomer is contained in the cyclohexane-insoluble matter of the hybrid resin.

In addition to the monovalent long-chain monomer discussed above, the monomers used for the polyester unit in the hybrid resin according to this embodiment include a polyalcohol (divalent or polyvalent alcohol) and a polycarboxylic acid (divalent or polyvalent carboxylic acid) or an anhydride or lower alkyl ester thereof. To prepare a branched polymer, partial intramolecular crosslinking is effective, and a polyvalent polyfunctional compound can be used therefor. Thus, the starting monomers of the polyester unit can include a polyvalent carboxylic acid, an anhydride or lower alkyl ester thereof, and/or a polyvalent alcohol.

Examples of divalent carboxylic acids include maleic acid, fumaric acid, citraconic acid, itaconic acid, glutaconic acid, phthalic acid, isophthalic acid, terephthalic acid, succinic acid, adipic acid, sebacic acid, azelaic acid, malonic acid, n-dodecenylsuccinic acid, isododecenylsuccinic acid, n-dodecylsuccinic acid, isododecylsuccinic acid, n-octenylsuccinic acid, n-octylsuccinic acid, isooctenylsuccinic acid, isooctylsuccinic acid, and anhydrides and lower alkyl esters thereof. Particularly preferred are maleic acid, fumaric acid, terephthalic acid, and n-dodecenylsuccinic acid.

Examples of polyvalent carboxylic acids and anhydrides and lower alkyl esters thereof include 1,2,4-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl)methane, 1,2,7,8-octanetetracarboxylic acid, pyromellitic acid, Empol trimer acid, and anhydrides and lower alkyl esters thereof. Particularly preferred are 1,2,4-benzenetricarboxylic acid and derivatives thereof (i.e., trimellitic acid), which are inexpensive and facilitate reaction control. These divalent and polyvalent carboxylic acids can be used alone or in combination.

Examples of divalent alcohols include alkylene oxide adducts of bisphenol A (e.g., polyoxypropylene(2.2)-2,2-bis(4-hydroxyphenyl)propane, polyoxypropylene(3.3)-2,2-bis(4-hydroxyphenyl)propane, polyoxyethylene(2.0)-2,2-bis(4-hydroxyphenyl)propane, polyoxypropylene(2.0)-polyoxyethylene(2.0)-2,2-bis(4-hydroxyphenyl)propane, and polyoxypropylene(6)-2,2-bis(4-hydroxyphenyl)propane), ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, polytetramethylene glycol, bisphenol A, and hydrogenated bisphenol A. Particularly preferred are alkylene oxide adducts of bisphenol A, ethylene glycol, 1,2-propylene glycol, 1,3-propylene glycol, and neopentyl glycol.

Examples of polyvalent alcohols include sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, 2-methylpropanetriol, 2-methyl-1,2,4-butanetriol, trimethylolethane, trimethylolpropane, and 1,3,5-trihydroxymethylbenzene. Particularly preferred are glycerol, trimethylolpropane, and pentaerythritol. These divalent and polyvalent alcohols can be used alone or in combination.

In addition, catalysts such as those commonly used for polyesterification can be used, including metals such as tin, titanium, antimony, manganese, nickel, zinc, lead, iron, magnesium, calcium, and germanium; and compounds containing such metals (dibutyltin oxide, ortho-dibutyl titanate, tetrabutyl titanate, zinc acetate, lead acetate, cobalt acetate, sodium acetate, and antimony trioxide).

In this embodiment, at least styrene can be used as a vinyl monomer for forming the vinyl polymer unit in the hybrid resin. Styrene is advantageous for improving the rigidity and viscosity of the vinyl polymer unit because most of its molecular structure is occupied by an aromatic ring. To achieve the above range of TgA, the styrene content is preferably 70 to 100 mol %, more preferably 85 to 100 mol %, of the vinyl monomers.

Examples of vinyl monomers other than styrene for forming the vinyl polymer unit include the following styrene monomers and acrylic acid monomers.

Examples of styrene monomers include styrenes such as o-methylstyrene, m-methylstyrene, p-methylstyrene, p-phenylstyrene, p-ethylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene, p-chlorostyrene, 3,4-dichlorostyrene, m-nitrostyrene, o-nitrostyrene, and p-nitrostyrene.

Examples of acrylic acid monomers include acrylic acid and acrylic acid esters such as acrylic acid, methyl acrylate, ethyl acrylate, propyl acrylate, n-butyl acrylate, isobutyl acrylate, n-octyl acrylate, dodecyl acrylate, 2-ethylhexyl acrylate, stearyl acrylate, 2-chloroethyl acrylate, and phenyl acrylate; a-methylene aliphatic monocarboxylic acids and esters thereof such as methacrylic acid, methyl methacrylate, ethyl methacrylate, propyl methacrylate, n-butyl methacrylate, isobutyl methacrylate, n-octyl methacrylate, dodecyl methacrylate, 2-ethylhexyl methacrylate, stearyl methacrylate, phenyl methacrylate, dimethylaminoethyl methacrylate, and diethylaminoethyl methacrylate; and acrylic and methacrylic acid derivatives such as acrylonitrile, methacrylonitrile, and acrylamide.

Other examples of monomers for the vinyl polymer unit include monomers having a hydroxyl group, including acrylic and methacrylic acid esters such as 2-hydroxylethyl acrylate, 2-hydroxylethyl methacrylate, and 2-hydroxylpropyl methacrylate; and styrenes such as 4-(1-hydroxy-1-methylbutyl)styrene and 4-(1-hydroxy-1-methylhexyl)styrene.

Optionally, various monomers capable of vinyl polymerization can be used in combination for the vinyl polymer unit. Examples of such monomers include ethylenically unsaturated monoolefins such as ethylene, propylene, butylene, and isobutylene; unsaturated polyenes such as butadiene and isoprene; halogenated vinyl compounds such as vinyl chloride, vinylidene chloride, vinyl bromide, vinyl fluoride; vinyl esters such as vinyl acetate, vinyl propionate, and vinyl benzoate; vinyl ethers such as vinyl methyl ether, vinyl ethyl ether, and vinyl isobutyl ether; vinyl ketones such as vinyl methyl ketone, vinyl hexyl ketone, and methyl isopropenyl ketone; N-vinyl compounds such as N-vinylpyrrole, N-vinylcarbazole, N-vinylindole, and N-vinylpyrrolidone; vinylnaphthalenes; unsaturated dibasic acids such as maleic acid, citraconic acid, itaconic acid, alkenylsuccinic acid, fumaric acid, and mesaconic acid; unsaturated dibasic anhydrides such as maleic anhydride, citraconic anhydride, itaconic anhydride, and alkenylsuccinic anhydride; half-esters of unsaturated basic acids such as methyl maleate half-ester, ethyl maleate half-ester, butyl maleate half-ester, methyl citraconate half-ester, ethyl citraconate half-ester, butyl citraconate half-ester, methyl itaconate half-ester, methyl alkenylsuccinate half-ester, methyl fumarate half-ester, and methyl mesaconate half-ester; unsaturated basic acid esters such as dimethyl maleate and dimethyl fumarate; anhydrides of α,β-unsaturated acids such as acrylic acid, methacrylic acid, crotonic acid, and cinnamic acid; anhydrides of the α,β-unsaturated acids with lower fatty acids; and monomers having a carboxyl group, such as alkenylmalonic acid, alkenylglutaric acid, alkenyladipic acid, and anhydrides and monoesters thereof.

Optionally, the vinyl polymer unit can be crosslinked by a crosslinking monomer. Examples of crosslinking monomers include aromatic divinyl compounds, diacrylates linked by an alkyl chain, diacrylates linked by an alkyl chain containing an ether bond, diacrylates linked by a chain containing an aromatic group and an ether bond, polyester diacrylates, and polyfunctional crosslinking agents.

Examples of aromatic divinyl compounds include divinylbenzene and divinylnaphthalene.

Examples of diacrylates linked by an alkyl chain include ethylene glycol diacrylate, 1,3-butylene glycol diacrylate, 1,4-butanediol diacrylate, 1,5-pentanediol diacrylate, 1,6-hexanediol diacrylate, neopentyl glycol diacrylate, and the above compounds whose acrylate groups are replaced by methacrylate groups.

Examples of diacrylates linked by an alkyl chain containing an ether bond include diethylene glycol diacrylate, triethylene glycol diacrylate, tetraethylene glycol diacrylate, polyethylene glycol (400) diacrylate, polyethylene glycol (600) diacrylate, dipropylene glycol diacrylate, and the above compounds whose acrylate groups are replaced by methacrylate groups.

Examples of diacrylates linked by a chain containing an aromatic group and an ether bond include polyoxyethylene(2)-2,2-bis(4-hydroxyphenyl)propane diacrylate, polyoxyethylene(4)-2,2-bis(4-hydroxyphenyl)propane diacrylate, and the above compounds whose acrylate groups are replaced by methacrylate groups. Examples of polyester diacrylates include those sold under the trade name MANDA from Nippon Kayaku Co., Ltd.

Examples of polyfunctional crosslinking agents include pentaerythritol triacrylate, trimethylolethane triacrylate, trimethylolpropane triacrylate, tetramethylolmethane tetraacrylate, oligoester acrylate, and the above compounds whose acrylate groups are replaced by methacrylate groups; triallyl cyanurate; and triallyl trimellitate.

The vinyl polymer unit can be formed using a polymerization initiator. For high efficiency, the content of the initiator can be from 0.05 to 10 parts by mass per 100 parts by mass of the monomers.

Examples of polymerization initiators include 2,2′-azobisisobutyronitrile, 2,2′-azobis(4-methoxy-2,4-dimethylvaleronitrile), 2,2′-azobis(2,4-dimethylvaleronitrile), 2,2′-azobis(2-methylbutyronitrile), dimethyl-2,2′-azobisisobutyrate, 1,1′-azobis(1-cyclohexanecarbonitrile), 2-carbamoylazoisobutyronitrile, 2,2′-azobis(2,4,4-trimethylpentane), 2-phenylazo-2,4-dimethyl-4-methoxyvaleronitrile, 2,2′-azobis(2-methylpropane), methyl ethyl ketone peroxide, acetylacetone peroxide, cyclohexanone peroxide, 2,2-bis(t-butylperoxy)butane, t-butyl hydroperoxide, cumene hydroperoxide, 1,1,3,3-tetramethylbutyl hydroperoxide, di-t-butyl peroxide, t-butylcumyl peroxide, dicumyl peroxide, α,α′-bis(t-butylperoxyisopropyl)benzene, isobutyl peroxide, octanoyl peroxide, decanoyl peroxide, lauroyl peroxide, 3,5,5-trimethylhexanoyl peroxide, benzoyl peroxide, m-trioyl peroxide, diisopropyl peroxydicarbonate, di-2-ethylhexyl peroxydicarbonate, di-n-propyl peroxydicarbonate, di-2-ethoxyethyl peroxycarbonate, dimethoxyisopropyl peroxydicarbonate, di(3-methyl-3-methoxybutyl) peroxycarbonate, acetylcyclohexylsulfonyl peroxide, t-butyl peroxyacetate, t-butyl peroxyisobutyrate, t-butylperoxy neodecanoate, t-butylperoxy-2-ethyl hexanoate, t-butylperoxy laurate, t-butyl peroxybenzoate, t-butyl peroxyisopropylcarbonate, di-t-butyl peroxyisophthalate, t-butyl peroxyallylcarbonate, t-amylperoxy-2-ethyl hexanoate, di-t-butyl peroxyhexahydroterephthalate, and di-t-butyl peroxyazelate.

The hybrid resin, used as the binder resin, is a resin in which a polyester unit and a vinyl polymer unit are chemically bound.

Thus, polymerization is performed using a compound that can react with the monomers of the two resins (hereinafter “bireactive compound”). Examples of bireactive compounds include fumaric acid, acrylic acid, methacrylic acid, citraconic acid, maleic acid, and dimethyl fumarate. Particularly preferred are fumaric acid, acrylic acid, and methacrylic acid.

The hybrid resin can be prepared by simultaneously or sequentially reacting the starting monomers of the polyester unit and the vinyl polymer unit. For ease of molecular weight control, a vinyl polymer monomer and an unsaturated polyester resin can be subjected to addition polymerization before the starting monomers of the polyester unit is subjected to condensation polymerization.

The toner according to this embodiment can contain a release agent. Examples of release agents include aliphatic hydrocarbon waxes such as low-molecular-weight polyethylene, low-molecular-weight polypropylene, low-molecular-weight olefin copolymers, microcrystalline wax, paraffin wax, and Fischer-Tropsch wax; oxides of aliphatic hydrocarbon waxes, such as polyethylene oxide wax; waxes based on fatty acid esters, such as aliphatic hydrocarbon ester waxes; partially or completely deoxidized fatty acid esters such as deoxidized carnauba wax; fatty acids partially esterified with polyalcohols, such as behenic acid monoglyceride; and hydroxyl-containing methyl esters obtained by hydrogenation of vegetable oils.

In this embodiment, aliphatic hydrocarbon waxes and ester waxes can be selected for ease of preparation of a release agent dispersion, compatibility with the resulting toner, resistance to elution from the toner during fusing, and releasability.

Ester waxes have an ester bond per molecule, and both natural ester waxes and synthetic ester waxes can be used. Examples of synthetic ester waxes include monoester waxes synthesized from a long-chain linear saturated fatty acid and a long-chain linear saturated alcohol. The long-chain linear saturated fatty acid is represented by the general formula CₙH₂ₙ₊₁COOH, where n can be from 5 to 28. The long-chain linear saturated alcohol is represented by the general formula CₙH₂ₙ₊₁OH, where n can be from 5 to 28. Examples of natural ester waxes include candelilla wax, carnauba wax, rice wax, and derivatives thereof.

In DSC, the release agent preferably has its maximum endothermic peak in the range from 60° C. to 120° C., more preferably from 95° C. to 120° C.

The content of the release agent can be from 1 to 20 parts by mass per 100 parts by mass of the binder resin.

The toner according to this embodiment can be either a magnetic toner or a nonmagnetic toner. If the toner is used as a magnetic toner, it can contain a magnetic iron oxide. Examples of magnetic iron oxides include iron oxides such as magnetite, maghemite, and ferrite.

The content of the magnetic iron oxide in the toner is preferably from 30% to 120% by mass, more preferably from 45% to 95% by mass.

The magnetic iron oxide has a coercivity of from 1.6 to 12.0 kA/m and a saturation magnetization of from 50.0 to 200.0 Am²/kg (preferably from 50.0 to 100.0 Am²/kg) at an external magnetic field of 795.8 kA/m. The magnetic iron oxide can have a residual magnetization of from 2.0 to 20.0 Am²/kg. The magnetic properties of the magnetic iron oxide can be measured using a vibrating sample magnetometer, for example, VSM P-1-10 (available from Toei Industry Co., Ltd.).

If the toner according to this embodiment is used as a nonmagnetic toner, it can contain one or more known pigments or dyes, including carbon black, as a colorant. The content of the colorant is preferably from 0.1 to 60.0 parts by mass, more preferably from 0.5 to 50.0 parts by mass, per 100.0 parts by mass of the resin components.

The toner according to this embodiment can contain an inorganic fine powder. Examples of inorganic fine powders include fine powder silica such as wet silica and dry silica; and treated silica subjected to surface treatment with a silane coupling agent, titanium coupling agent, or silicone oil. Particularly preferred is dry silica, which is produced by vapor-phase oxidation of a silicon halide.

The inorganic fine powder preferably has an average primary particle size of from 0.001 to 2 μm, more preferably from 0.002 to 0.2 μm. For high fluidity, the inorganic fine powder can have a BET specific surface area of from 50 to 300 m²/g.

The inorganic fine powder can be subjected to hydrophobing treatment with an organosilicon compound. Examples of organosilicon compounds include hexamethyldisilazane, trimethylsilane, trimethylchlorosilane, trimethylethoxysilane, dimethyldichlorosilane, methyltrichlorosilane, allyldimethylchlorosilane, allylphenyldichlorosilane, benzyldimethylchlorosilane, bromomethyldimethylchlorosilane, α-chloroethyltrichlorosilane, β-chloroethyltrichlorosilane, chloromethyldimethylchlorosilane, triorganosilylmercaptan, trimethylsilylmercaptan, triorganosilyl acrylate, vinyldimethylacetoxysilane, dimethylethoxysilane, dimethyldimethoxysilane, diphenyldiethoxysilane, 1-hexamethyldisiloxane, 1,3-divinyltetramethyldisiloxane, 1,3-diphenyltetramethyldisiloxane, and dimethylpolysiloxanes having from 2 to 12 siloxane units per molecule and having a hydroxyl group attached to a silicon atom in each of the end units thereof. These are used alone or as a mixture of two or more.

The inorganic fine powder can be subjected to silicone oil treatment alone or in combination with the above hydrophobing treatment. The silicone oil can have a viscosity at 25° C. of from 30 to 1,000 mm²/s. Examples of silicone oils include dimethylsilicone oil, methylphenylsilicone oil, α-methylstyrene-modified silicone oil, chlorophenylsilicone oil, and fluorine-modified silicone oil.

The content of the inorganic fine powder is preferably from 0.01 to 8.0 parts by mass, more preferably from 0.1 to 4.0 parts by mass, per 100.0 parts by mass of the toner particles.

The toner according to this embodiment can optionally contain other additives. Examples of additives include charge adjuvants, conductors, fluidity improvers, anticaking agents, release agents for heat roller fusing, and lubricants and abrasives such as fine resin particles and fine inorganic particles.

Examples of lubricants include polyethylene fluoride powder, zinc stearate powder, and polyvinylidene fluoride powder, of which polyvinylidene fluoride powder is preferred. Examples of abrasives include cerium oxide powder, silicon carbide powder, and strontium titanate powder.

Examples of processes for manufacturing the toner particles according to this embodiment include pulverization, solution suspension, and emulsion aggregation, of which pulverization is preferred. Specifically, the toner particles according to this embodiment can be manufactured as follows. For example, a binder resin, a colorant, and an acid-modified polyolefin resin are sufficiently mixed together using a mixer such as a Henschel mixer or ball mill. The mixture is then melted and kneaded using a heat kneading device such as a heating roller, kneader, or extruder. After the melt is solidified by cooling, the solid is pulverized and sized. Optional additives are then added and sufficiently mixed using a mixer such as a Henschel mixer to yield a toner.

Methods for measuring material properties will now be described. The Examples below are based on these methods.

### Methods for Determining Cyclohexane-Insoluble Content, Cyclohexane-Soluble Content, and THF-Soluble Content

The cyclohexane-insoluble content and cyclohexane-soluble content of the hybrid resin are determined as follows.

About 5.0 g of the hybrid resin (W1) is weighed out and is placed in an extraction thimble weighed in advance (e.g., one sold under the trade name No. 86R (size: 28×100 mm) by Advantec Toyo Kaisha, Ltd.). The resin is dissolved in 200 mL of cyclohexane at 25.0° C. for 16 hours.

After the dissolution is completed, the extraction thimble is removed and dried in air and is then dried in vacuo at 40.0° C. for 8 hours. The mass of the dried extraction thimble, including the insoluble matter, is measured, and the mass of the extraction thimble is subtracted therefrom to calculate the mass of the insoluble matter (W2).

If any component other than the resin components is contained, the content thereof (W3) can be subtracted to determine the cyclohexane-insoluble content, as represented by the following equation:

Cyclohexane-insoluble content (% by mass)={(W2−W3)/(W1−W3)}×100

After the extraction thimble is removed in the above procedure, the solvent is evaporated off from the filtrate using an evaporator. The residue is left standing in a vacuum drier at 40° C. for 16 hours to yield cyclohexane-soluble matter.

The THF-soluble content of the hybrid resin is determined as follows.

About 5.0 g of the resin is weighed out and is placed in an extraction thimble. The resin is dissolved in 200 mL of THF at 25.0° C. for 16 hours. After the extraction thimble is removed, the solvent is evaporated off from the filtrate using an evaporator. The residue is left standing in a vacuum drier at 40° C. for 16 hours to yield THF-soluble matter.

### Measurement of Glass Transition Temperature

The glass transition temperature TgA of the cyclohexane-soluble matter and the glass transition temperature TgB of the THF-soluble matter are measured as follows. The glass transition temperature is measured using a Q1000 differential scanning calorimeter (available from TA Instruments) in accordance with ASTM D3418-82. The temperature calibration of the detector of the instrument is based on the melting points of indium and zinc, and the energy calibration is based on the heat of fusion of indium.

Specifically, about 5 mg of a measurement sample (cyclohexane-soluble matter or THF-soluble matter) is accurately weighed out and is placed in an aluminum pan. Measurement is performed at normal temperature and humidity using an empty aluminum pan as a reference. The measurement temperature range is from 30° C. to 200° C., and the heating rate is 10° C/min. During the measurement, the sample is heated to 200° C., is cooled to 30° C., and is heated again. In the DSC curve obtained from this heating process, the intersection of a line at a midpoint between a baseline before a change in specific heat and a baseline after the change in specific heat and the differential thermal curve is determined as the glass transition temperature.

### Measurement of Peak Top of and Amount of Heat Absorbed at Endothermic Peak of DSC Curve for Cyclohexane-Insoluble Matter

The peak top of and amount of heat absorbed at an endothermic peak of a DSC curve for the cyclohexane-insoluble matter are measured as follows. An endothermic peak of a DSC curve for the cyclohexane-insoluble matter is measured using a Q1000 differential scanning calorimeter (available from TA Instruments) in accordance with ASTM D3418-82. The temperature calibration of the detector of the instrument is based on the melting points of indium and zinc, and the energy calibration is based on the heat of fusion of indium.

Specifically, about 5 mg of a measurement sample (cyclohexane-soluble matter or THF-soluble matter) is accurately weighed out and is placed in an aluminum pan. Measurement is performed at normal temperature and humidity using an empty aluminum pan as a reference. The measurement temperature range is from 30° C. to 200° C., and the heating rate is 10° C/min. During the measurement, the sample is heated to 200° C., is cooled to 30° C., and is heated again. In a DSC curve obtained from this heating process, the peak top temperature of the maximum endothermic peak within the temperature range from 30° C. to 200° C. is determined. The amount of heat absorbed AH at the endothermic peak is the integral of the endothermic peak.

### Method for Measuring Weight Average Particle Size (D4)

The weight average particle size (D4) of the toner is measured as follows. Measurement is performed using a Coulter Counter® Multisizer 3 (available from Beckman Coulter, Inc.), which is an accurate particle size distribution analyzer based on the Coulter principle and having a 100 μm aperture tube, and Beckman Coulter Multisizer 3 Version 3.51 software (available from Beckman Coulter, Inc.), which is the associated dedicated software for measurement condition settings and measurement data analysis. The number of effective measurement channels is 25,000. The resulting data is analyzed to determine the weight average particle size (D4).

The aqueous electrolyte solution used for measurement can be one prepared by dissolving about 1% by mass of sodium chloride (GR) in ion exchange water, for example, ISOTON II (available from Beckman Coulter, Inc.).

Before the measurement and analysis, the settings of the dedicated software are specified as follows.

In the “Standard Operating Method (SOM)” screen of the dedicated software, the total count in the control mode is set to 50,000 particles. The number of runs is set to 1. The kd value is set to a value obtained using Standard Particle 10.0 μm (available from Beckman Coulter, Inc.). The threshold/noise level is automatically set by pressing the measure button for the threshold/noise level. The current is set to 1,600 μA. The gain is set to 2. The electrolyte solution is set to ISOTON II. The “Flush Aperture Tube After Each Run” is checked.

In the “Pulse to Size Settings” screen of the dedicated software, the bin spacing is set to the log diameter, the number of size bins is set to 256, and the size range is set to from 2 to 60 μm.

The specific measurement procedure is as follows:

(1) About 200 mL of the aqueous electrolyte solution is placed in a 250 mL round-bottom glass beaker dedicated to the Multisizer 3. The beaker is set on a sample stand. The solution is stirred with a stirrer rod counterclockwise at 24 revolutions per second. The “Flush Aperture” function of the analysis software is used to remove contaminants and bubbles from the aperture tube.

(2) About 30 mL of the electrolyte solution is placed in a 100 mL flat-bottom glass beaker. About 0.3 mL of a dispersant is then added to the solution. The dispersant is a dilution prepared by diluting Contaminon N (10% by mass aqueous solution of a neutral detergent at pH 7 for cleaning precision instruments that contains a nonionic surfactant, an anionic surfactant, and an organic builder, available from Wako Pure Chemical Industries, Ltd.) three times by mass with ion exchange water.

(3) A predetermined amount of ion exchange water is placed in a water bath of a Tetora 150 ultrasonic dispersion system (available from Nikkaki Bios Co., Ltd.), which includes two built-in oscillators with an oscillation frequency of 50 kHz disposed with a phase difference of 180° and which has an electrical output power of 120 W. About 2 mL of Contaminon N is added to the water bath.

(4) The beaker in step (2) is set in a beaker-holding hole of the ultrasonic dispersion system, and the ultrasonic dispersion system is activated. The height of the beaker is adjusted so as to maximize the resonance of the surface of the aqueous electrolyte solution in the beaker.

(5) While the aqueous electrolyte solution in the beaker in step (4) is sonicated, about 10 mg of the toner is gradually added to the aqueous electrolyte solution and is dispersed therein. The sonication is continued for a further 60 seconds. During the sonication, the water in the water bath is maintained at from 10° C. to 40° C.

(6) The toner-dispersed aqueous electrolyte solution prepared in step (5) is added dropwise to the round-bottom beaker set on the sample stand in step (1) using a pipette such that the measurement concentration is about 5%. Measurement is performed on 50,000 particles.

(7) The resulting data is analyzed by the dedicated software associated with the instrument to determine the weight average particle size (D4). In the dedicated software, the “Mean Diameter” in the analysis/volume statistics (arithmetic mean) screen displayed when the graph/volume % setting is selected is the weight average particle size (D4).

### Measurement of Magnetic Properties of Magnetic Iron Oxide Particles

A VSM-P7 vibrating sample magnetometer (available from Toei Industry Co., Ltd.) is used to perform measurement at a sample temperature of 25° C. and an external magnetic field of 795.8 kA/m.

### Measurement of Average Primary Particle Size of Magnetic Iron Oxide Particles

The average primary particle size is determined by examining the magnetic iron oxide particles under a scanning electron microscope (at 40,000× magnification), measuring the Feret's diameters of 200 particles, and calculating the number average particle size thereof. In this embodiment, an S-4700 scanning electron microscope (available from Hitachi, Ltd.) can be used.

### EXAMPLES

The present invention is further illustrated by the following examples, where the polyester unit of the hybrid resin may be referred to as “PES portion” and the vinyl polymer unit may be referred to as “StAc portion.”

### Manufacture of Binder Resin 1

### Composition of PES Portion (P-1)

Bisphenol A ethylene oxide (2.2 mol adduct): 100.0 molar parts
Terephthalic acid: 65.0 molar parts
Trimellitic anhydride: 25.0 molar parts
Acrylic acid: 10.0 molar parts
Monovalent saturated alcohol having 50 carbon atoms:
5.0 molar parts

In a four-neck flask, 80 parts by mass of a mixture of the above polyester monomers was placed. The flask was equipped with a pressure-reducing device, a water-separating device, a nitrogen-gas introducing device, a temperature-measuring device, and a stirring device. The mixture was stirred at 160° C. in a nitrogen atmosphere. To the flask, 20 parts by mass of vinyl monomers for forming the StAc portion (S-1: 90.0 molar parts of styrene and 10.0 molar parts of 2-ethylhexyl acrylate) and 1 part by mass of benzoyl peroxide, serving as a polymerization initiator, were added dropwise using a dropping funnel for 4 hours, and the mixture was reacted at 160° C. for 5 hours.

The mixture was then heated to 230° C. Dibutyltin oxide was added to the mixture in an amount of 0.2 part by mass of the total amount of polyester monomers, and condensation polymerization was performed for 6 hours. After the reaction was complete, the product is removed, cooled, and pulverized to yield Binder Resin 1. The properties of Binder Resin 1 are shown in Table 3.

### Manufacture of Binder Resins 2 to 7 and 18

Binder Resins 2 to 7 and 18 were prepared in the same manner as Binder Resin 1 except that the composition of the PES portion was changed as in Table 1, that the composition of the StAc portion was changed as in Table 2, and that the conditions, such as the content of the PES portion, were changed as in Table 3. The properties of these binder resins are shown in Table 3.

### Manufacture of Binder Resin 8

### Composition of PES Portion (P-8)

Bisphenol A ethylene oxide (2.2 mol adduct): 40.0 molar parts
Bisphenol A propylene oxide (2.2 mol adduct): 60.0 molar parts
Terephthalic acid: 69.0 molar parts
Adipic acid: 3.0 molar parts
Trimellitic anhydride: 18.0 molar parts
Acrylic acid: 10.0 molar parts

In a four-neck flask, 80 parts by mass of a mixture of the above polyester monomers was placed. The flask was equipped with a pressure-reducing device, a water-separating device, a nitrogen-gas introducing device, a temperature-measuring device, and a stirring device. The mixture was stirred at 160° C. in a nitrogen atmosphere. To the flask, 20 parts by mass of vinyl monomers for forming the StAc portion (S-5: 85.0 molar parts of styrene and 15.0 molar parts of butyl acrylate) and 1 part by mass of benzoyl peroxide, serving as a polymerization initiator, were added dropwise using a dropping funnel for 4 hours, and the mixture was reacted at 160° C. for 5 hours. The mixture was then heated to 230° C. Dibutyltin oxide was added to the mixture in an amount of 0.2 part by mass of the total amount of polyester monomers, and condensation polymerization was performed for 6 hours. The mixture was further heated to 240° C. To the mixture, 5.0 molar parts of a monovalent saturated alcohol having 84 carbon atoms was added, and condensation polymerization was performed for 2 hours (second condensation polymerization). After the reaction was complete, the product is removed, cooled, and pulverized to yield Binder Resin 8. The properties of Binder Resin 8 are shown in Table 3.

### Manufacture of Binder Resins 9 to 13 and 15

Binder Resins 9 to 13 and 15 were prepared in the same manner as Binder Resin 8 except that the composition of the PES portion was changed as in Table 1, that the composition of the StAc portion was changed as in Table 2, and that the conditions, such as the content of the PES portion, were changed as in Table 3. The properties of these binder resins are shown in Table 3.

### Manufacture of Binder Resins 14 and 16

In a four-neck flask, 100 parts by mass of the polyester monomer mixture shown in Table 1 (P-13 or P-15) and 0.2 part by mass of dibutyltin oxide were placed. The flask was equipped with a pressure-reducing device, a water-separating device, a nitrogen-gas introducing device, a temperature-measuring device, and a stirring device. The mixture was heated to 230° C. in a nitrogen atmosphere to perform condensation polymerization. After the reaction was complete, the product is removed, cooled, and pulverized to yield Binder Resins 14 and 16. The properties of these binder resins are shown in Table 3.

### Manufacture of Binder Resin 17

A mixture of 100 parts by mass of the vinyl monomers shown in Table 2 (S-8) and 5 parts by mass of benzoyl peroxide, serving as a polymerization initiator, was added dropwise to 200 parts by mass of heated xylene for 4 hours. The polymerization was completed under xylene reflux, and the solvent was distilled off under reduced pressure. After the reaction was complete, the product is removed, cooled, and pulverized to yield Binder Resin 17. The properties of Binder Resin 17 are shown in Table 3.

TABLE 1
List of resin compositions (PES portion)

| | | | | | | | | Acrylic | | Number of | |
|---|---|---|---|---|---|---|---|---|---|---|---|
| | BPA-PO | BPA-EO | DSA | TPA | Adipic acid | TMA | FA | acid | | carbon atoms of | Long-chain |
| | (molar | (molar | (molar | (molar | (molar | (molar | (molar | (molar | Type of long- | long-chain | monomer |
| | parts) | parts) | parts) | parts) | parts) | parts) | parts) | parts) | chain monomer | monomer | (molar parts) |
| P-1 | 0.0 | 100.0 | — | 65.0 | — | 25.0 | — | 10.0 | Saturated alcohol | 50 | 5.0 |
| | | | | | | | | | (monovalent) | | |
| P-2 | 15.0 | 85.0 | — | 63.0 | — | 25.0 | 2.0 | 10.0 | Saturated alcohol | 70 | 5.0 |
| | | | | | | | | | (monovalent) | | |
| P-3 | 60.0 | 40.0 | — | 67.0 | — | 23.0 | — | 10.0 | Saturated alcohol | 70 | 5.0 |
| | | | | | | | | | (monovalent) | | |
| P-4 | 95.0 | 5.0 | — | 65.0 | 5.0 | 20.0 | — | 10.0 | Saturated alcohol | 26 | 5.0 |
| | | | | | | | | | (monovalent) | | |
| P-5 | 60.0 | 40.0 | — | 62.0 | 5.0 | 20.0 | 3.0 | 10.0 | Saturated alcohol | 26 | 5.0 |
| | | | | | | | | | (monovalent) | | |
| P-6 | 60.0 | 40.0 | 1.0 | 62.0 | 7.0 | 20.0 | — | 10.0 | Saturated alcohol | 80 | 5.0 |
| | | | | | | | | | (monovalent) | | |
| P-7 | 60.0 | 40.0 | — | 69.0 | 3.0 | 18.0 | — | 10.0 | Saturated alcohol | 84 | 5.0 |
| | | | | | | | | | (monovalent) | | |
| P-8 | 60.0 | 40.0 | — | 69.0 | 3.0 | 18.0 | — | 10.0 | Saturated alcohol | 84 | 5.0 |
| | | | | | | | | | (monovalent) | | (added later) |
| P-9 | 55.0 | 45.0 | — | 69.0 | 3.0 | 18.0 | — | 10.0 | Saturated fatty | 84 | 5.0 |
| | | | | | | | | | acid | | (added later) |
| P-10 | 60.0 | 40.0 | — | 69.0 | 3.0 | 18.0 | — | 10.0 | Saturated alcohol | 105 | 5.0 |
| | | | | | | | | | (monovalent) | | (added later) |
| P-11 | 55.0 | 45.0 | — | 69.0 | 3.0 | 18.0 | — | 10.0 | Saturated fatty | 14 | 5.0 |
| | | | | | | | | | acid | | (added later) |
| P-12 | 60.0 | 40.0 | 5.0 | 65.0 | — | 20.0 | — | 10.0 | Saturated alcohol | 84 | 5.0 |
| | | | | | | | | | (monovalent) | | (added later) |
| P-13 | 90.0 | 10.0 | — | 75.0 | — | 25.0 | — | — | Saturated alcohol | 84 | 5.0 |
| | | | | | | | | | (monovalent) | | (added later) |
| P-14 | 60.0 | 40.0 | — | 70.0 | — | 20.0 | — | 10.0 | Saturated alcohol | 84 | 5.0 |
| | | | | | | | | | (monovalent) | | (added later) |
| P-15 | 60.0 | 40.0 | — | 60.0 | 20.0 | 20.0 | — | — | Saturated alcohol | 84 | 5.0 |
| | | | | | | | | | (monovalent) | | (added later) |
| P-16 | 60.0 | 40.0 | 15.0 | 65.0 | — | 15.0 | — | 5.0 | — | — | — |

BPA-PO: bisphenol A propylene oxide adduct
BPA-EO: bisphenol A ethylene oxide adduct
DSA: dodecenylsuccinic acid
TPA: terephthalic acid
TMA: trimellitic anhydride
FA: fumaric acid
*1: In table, “added later” means that long-chain monomer was added before second condensation polymerization.

TABLE 2
Resin composition

| | St | 2EHA | BA |
|---|---|---|---|
| | (molar parts) | (molar parts) | (molar parts) |
| S-1 | 90 | 10 | — |
| S-2 | 94 | 6 | — |
| S-3 | 85 | 15 | — |
| S-4 | 87 | 13 | — |
| S-5 | 85 | — | 15 |
| S-6 | 88 | 12 | — |
| S-7 | 86 | — | 14 |
| S-8 | 70 | 30 | — |
| S-9 | 59 | 41 | — |

St: styrene
2EHA: 2-ethylhexyl acrylate
BA: n-butyl acrylate

TABLE 3
Method of manufacture and properties of resin

| | PES | StAc | Initiator | | | | | | | | Amount of | Number of |
|---|---|---|---|---|---|---|---|---|---|---|---|---|
| | portion | portion | content | | | Endothermic | | THF- | | | heat | carbon |
| | content | content | (parts | | TgA- | peak | Cyclohexane- | soluble | | | absorbed at | atoms of |
| | (parts by | (parts by | by | TgB | TgB | temperature | insoluble | content | | | endothermic | long-chain |
| | mass) | mass) | mass) | (° C.) | (° C.) | (° C.) | content (%) | (%) | Mp | Mw | peak (J/g) | monomer |
| Resin 1 | P-1/80 | S-1/20 | 1.0 | 42.0 | 15.0 | 75.0 | 95 | 14 | 7350 | 2.21 × | 4.81 | 50 |
| | | | | | | | | | | 10⁴ | | |
| Resin 2 | P-2/80 | S-2/20 | 1.0 | 43.0 | 26.0 | 85.0 | 90 | 20 | 7150 | 3.70 × | 4.05 | 70 |
| | | | | | | | | | | 10⁴ | | |
| Resin 3 | P-3/80 | S-2/20 | 1.0 | 46.0 | 23.0 | 85.0 | 89 | 15 | 8520 | 3.71 × | 4.07 | 70 |
| | | | | | | | | | | 10⁴ | | |
| Resin 4 | P-4/80 | S-3/20 | 1.0 | 36.0 | 3.0 | 65.0 | 95 | 16 | 7100 | 2.05 × | 5.23 | 26 |
| | | | | | | | | | | 10⁴ | | |
| Resin 5 | P-5/80 | S-3/20 | 1.0 | 33.0 | 6.0 | 65.0 | 94 | 15 | 6850 | 1.98 × | 5.25 | 26 |
| | | | | | | | | | | 10⁴ | | |
| Resin 6 | P-6/80 | S-4/20 | 1.0 | 31.0 | 15.0 | 91.0 | 90 | 13 | 6320 | 1.88 × | 3.75 | 80 |
| | | | | | | | | | | 10⁴ | | |
| Resin 7 | P-7/70 | S-5/30 | 1.5 | 50.0 | 1.0 | 107.0 | 75 | 30 | 8900 | 5.21 × | 3.31 | 84 |
| | | | | | | | | | | 10⁴ | | |
| Resin 8 | P-8/90 | S-5/10 | 0.5 | 50.0 | 2.0 | 107.0 | 97 | 12 | 8620 | 5.40 × | 3.35 | 84 |
| | | | | | | | | | | 10⁴ | | |
| Resin 9 | P-9/90 | S-5/10 | 0.5 | 49.0 | 2.0 | 103.0 | 99 | 15 | 8430 | 4.81 × | 3.40 | 84 |
| | | | | | | | | | | 10⁴ | | |
| Resin | P-8/60 | S-5/40 | 2.0 | 50.0 | 1.0 | 107.0 | 65 | 39 | 7500 | 3.21 × | 3.31 | 84 |
| 10 | | | | | | | | | | 10⁴ | | |
| Resin | P-10/80 | S-5/20 | 1.0 | 50.0 | 2.0 | 115.0 | 99 | 10 | 8200 | 4.26 × | 3.05 | 105 |
| 11 | | | | | | | | | | 10⁴ | | |
| Resin | P-11/80 | S-5/20 | 1.0 | 49.0 | 2.0 | 50.0 | 99 | 9 | 8370 | 4.83 × | 4.51 | 14 |
| 12 | | | | | | | | | | 10⁴ | | |
| Resin | P-12/60 | S-6/40 | 2.0 | 50.0 | 0.0 | 52.0 | 70 | 41 | 8160 | 3.33 × | 4.55 | 84 |
| 13 | | | | | | | | | | 10⁴ | | |
| Resin | P-13/100 | — | — | 50.0 | — | 52.0 | 100 | 15 | 10320 | 8.25 × | 4.50 | 84 |
| 14 | | | | | | | | | | 10⁴ | | |
| Resin | P-14/90 | S-7/10 | 0.5 | 52.0 | 1.0 | 52.0 | 99 | 15 | 7750 | 2.21 × | 4.53 | 84 |
| 15 | | | | | | | | | | 10⁴ | | |
| Resin | P-15/100 | — | — | 28.0 | — | 115.0 | 100 | 30 | 7430 | 2.98 × | 3.01 | 84 |
| 16 | | | | | | | | | | 10⁴ | | |
| Resin | — | S-8/100 | 5.0 | — | — | — | 2 | 80 | 4100 | 2.21 × | — | — |
| 17 | | | | | | | | | | 10³ | | |
| Resin | P-16/80 | S-9/20 | 1.0 | 28.0 | −53.0 | — | 99 | 10 | 6820 | 2.03 × | — | — |
| 18 | | | | | | | | | | 10⁴ | | |

### Example 1

### Preparation of Toner No. 1

Binder Resin 1: 100 parts by mass
Magnetic iron oxide particles a: 90 parts by mass (average particle size=0.14 μm, Hc (coercivity)=11.5 kA/m, σs (saturated magnetization)=90 Am²/kg, σr (residual magnetization)=16 Am²/kg)
T-77 charge control agent (available from Hodogaya Chemical Co., Ltd.): 2 parts by mass

The above materials were premixed using a Henschel mixer. The mixture was melted and kneaded using a double-screw kneading extruder. The retention time was controlled so that the temperature of the kneaded resin was 150° C. The resulting mixture was cooled, was roughly crushed using a hummer mill, and was pulverized using a turbo mill. The resulting fine powder was sized using a multi-division classifier based on the Coanda effect (an elbow-jet classifier available from Nittetsu Mining Co., Ltd.) to yield toner particles having a weight average particle size of 6.8 μm. To 100 parts by mass of the toner particles, 1.0 part by mass of hydrophobic fine silica powder (specific surface area measured by nitrogen adsorption according to BET method=140 m²/g) and 3.0 parts by mass of strontium titanate (volume average particle size=1.6 μm) were added and mixed. The mixture was passed through a 150 μm mesh to yield Toner No. 1. Toner No. 1 was evaluated as follows. The evaluations are shown in Table 5.

### Fusibility Evaluation

A fusing unit was removed from a commercially available digital copier (image PRESS 1135 available from CANON KABUSHIKI KAISHA) and was modified such that the fusing roller temperature was variable and the process speed was 1,000 mm/sec. This external fusing unit was left standing at low temperature and humidity (15° C. and 10% RH (L/L)) overnight. The fusing unit was powered early in the next morning, and printing was started immediately after the fusing roller temperature reached the target temperature. An unfused solid black image (amount of toner deposited=0.45 mg/cm²) was formed on 90 g/m² paper and Rezakku 66 embossed paper (151 g/m²). In addition, an unfused image including ten unfused solid patch images having a size of 10×10 mm and arranged regularly in line was formed at an end of 90 g/m² paper.

The heater temperature of the fusing unit was set to 100° C., the process speed was set to 1,000 mm/sec, and the nip width was set to 13 mm. With these settings, an unfused solid black image formed in the above manner was fused. The fusing temperature was then changed from 100° C. to 180° C. in increments of 10° C., and an unfused solid black image formed in the above manner was fused at each fusing temperature. The resulting fused images were rubbed with lens-cleaning paper at a load of 4.9 kPa by moving it backwards and forwards five times. Of the fused images whose image densities decreased by 10% or less after rubbing, the fusing temperature of the fused image having the lowest fusing temperature was selected as the fusing start temperature, based on which the low-temperature fusibility was evaluated as follows. The image density was measured using a Macbeth RD-914 densitometer (available from Macbeth) with an SPI auxiliary filter.

A: The fusing start temperature was 110° C. or lower.

B: The fusing start temperature was 120° C.

C: The fusing start temperature was 130° C.

D: The fusing start temperature was 140° C. or higher.

The heater temperature of the fusing unit was then set to 180° C., the process speed was set to 1,000 mm/sec, and the nip width was set to 13 mm. With these settings, an unfused image including patch images formed in the above manner was fused. The unevenness of fusing was evaluated based on the difference between the maximum and minimum gloss values of the ten patch images as follows. The gloss values were measured using an IG-310 Gloss Checker handheld glossmeter (available from HORIBA, Ltd.).

A: The difference between the maximum and minimum gloss values was less than 3.

B: The difference between the maximum and minimum gloss values was from 3 to less than 6.

C: The difference between the maximum and minimum gloss values was 6 or more.

### Storage Stability

In 100 mL of a resin container, 5 g of the toner was weighed out, and it was left standing at 50° C. for 7 days. The toner in the resin container was then visually inspected to evaluate the storage stability based on the following criteria:

A: The toner contained no lumps.

B: The toner contained some lumps, although they collapsed as the container was shaken.

C: The toner contained some lumps, and they remained as the container was shaken.

D: The toner contained large lumps, and few of them collapsed as the container was shaken.

### Material Dispersibility

The material dispersibility was evaluated as follows. A roughly crushed toner was deposited with a carbon paste at an edge of a glass slide about 1 mm thick and was coated with platinum (evaporation time=100 sec). The above sample was set on an SM-09010 cross-section polisher (CP) (available from JEOL Ltd.) and was processed to form a cross-section. A backscattered electron (BSE) image of the cross-section was examined under an S-4800 field-emission scanning electron microscope (FE-SEM) (available from Hitachi High-Technologies Corporation) at 100× magnification. The material dispersibility was evaluated based on the size of uncolored areas in the examination field of view as follows. These uncolored areas occur when highly viscous phases are separated in the binder resin and are attributed to the cyclohexane-soluble content of the hybrid resin. The uncolored areas contain no colorant. The presence of many or large uncolored areas indicates poor material dispersibility.

A: There was no uncolored area.

B: There were uncolored areas having a size of less than 2 μm.

C: There were uncolored areas having a size of 2 μm or more.

### Durability

The durability was evaluated by a durability test using a commercially available digital copier (image PRESS 1135 available from CANON KABUSHIKI KAISHA, modified such that the process speed was 1,000 mm/sec). In the durability test, an original image having a coverage of 5% (including five 20 mm square solid black patches arranged in the developing region) was printed on 20,000 sheets of paper at high temperature and humidity (30° C. and 80% RH (H/H)), at normal temperature and humidity (23° C. and 50% RH (N/N)), and at low temperature and humidity (15° C. and 10% RH (L/L). The average densities of the five solid black patches in the first and 20,000th prints were measured and compared with each other to evaluate the durability as follows. The image density is the density measured using a Macbeth RD-918 reflection densitometer (available from Macbeth) relative to that of a white image, i.e., a density of 0.00.

A: The density difference was less than 0.10.

B: The density difference was from 0.10 to less than 0.20.

C: The density difference was 0.20 or more.

### Harsh-Environment Storage Stability

In 100 mL of a resin container, 5 g of the toner was weighed out, and it was left standing in a constant-temperature, constant-humidity bath at 45° C. and 95% RH for 30 days. The degrees of aggregation of 5 g of the toner after left standing and 5 g of the toner that had not been left standing (before left standing) were measured using Powder Tester (available from Hosokawa Micron Corporation). In the measurement, 5 g of the toner was dropped onto a stack of 100-mesh, 200-mesh, and 400-mesh sieves. The sieves were vibrated at an amplitude of 0.6 mm for 15 seconds. The degree of aggregation was calculated from the amount of toner (g) remaining on each sieve by the following equation:

Degree of aggregation=(amount of toner remaining on 100-mesh sieve)×5+(amount of toner remaining on 200-mesh sieve)×3+(amount of toner remaining on 400-mesh sieve)×4

The harsh-environment storage stability was evaluated based on the following criteria:

A: The difference between the degrees of aggregation of the toners before and after left standing was less than 5.

B: The difference between the degrees of aggregation of the toners before and after left standing was from 5 to less than 10.

C: The difference between the degrees of aggregation of the toners before and after left standing was 10 or more.

The toner of Example 1 was rated as A for each of the evaluation items described above.

### Examples 2 to 10

### Preparation of Toner Nos. 2 to 10

Toner Nos. 2 to 10 were prepared as in Example 1 except that the composition was changed as in Table 4. In Table 4, the “tanδ peak” column shows whether in viscoelastometry the toner has a tans peak in the range from −50.0° C. to 10.0° C. Toner Nos. 2 to 10 were evaluated as in Example 1. The evaluations are shown in Table 5. The evaluations of Toner Nos. 2 to 10 are discussed below.

The toner of Example 2 was rated as B for unevenness of fusing. Because the temperature difference (TgA−TgB) was 26.0° C., the binder resin had a slightly large difference in melt viscosity within the resin.

The toner of Example 3 was rated as B for low-temperature fusibility. Because TgB was 46.0° C., the entire binder resin had slightly low mobility when melted. Thus, the effect of facilitating melting of the entire binder resin due to the polyester unit was not sufficiently utilized.

The toner of Example 4 was rated as B for low-temperature fusibility. Because the temperature difference (TgA−TgB) was 3.0° C., the hybrid resin had a slightly small difference in rigidity and viscosity between the vinyl polymer unit and the polyester unit. That is, the polyester unit, which was intended to improve the fusibility, had slightly high melt viscosity.

The toner of Example 5 was rated as B for storage stability. Because TgB was 33.0° C., the entire hybrid resin had slightly high mobility at room temperature. Thus, the effect of maintaining the rigidity and viscosity due to the vinyl polymer unit was slightly insufficient.

The toner of Example 6 was rated as B for storage stability because TgB was 31.0° C. In addition, the toner of Example 6 was rated as B for low-temperature fusibility. Because the endothermic peak temperature of the binder resin was 91.0° C., the effect of facilitating melting of the entire binder resin due to the polyester unit was slightly insufficient.

The toner of Example 7 was rated as C for low-temperature fusibility. Because TgB was 50.0° C., the effect of facilitating melting of the entire binder resin due to the polyester unit was not sufficiently utilized. In addition, because the endothermic peak temperature was 107.0° C., the effect of facilitating melting of the entire binder resin due to the polyester unit was slightly insufficient.

The toner of Example 8 was rated as B for harsh-environment storage stability. This toner had a loss tangent (tans) peak in the range of −50.0° C. to 10.0° C. That is, the long-chain monomer was slightly unevenly distributed in the toner.

The toner of Example 9 was rated as B for durability. Because the cyclohexane-insoluble content was 99.0%, the vinyl polymer unit, which provides high rigidity and viscosity, was limited in quantity and only locally present in the toner.

The toner of Example 10 was rated as B for material dispersibility. Because the cyclohexane-insoluble content was 65.0%, the vinyl polymer unit, which provides high rigidity and viscosity, was concentrated in a large number of areas in the toner.

### Comparative Examples 1 to 7

### Preparation of Toner Nos. 11 to 17

Toner Nos. 11 to 17 were prepared as in Example 1 except that the composition was changed as in Table 4. Toner Nos. 11 to 17 were evaluated as in Example 1. The evaluations are shown in Table 5. The evaluations of Toner Nos. 11 to 17 are discussed below.

The toner of Comparative Example 1 was rated as D for low-temperature fusibility. Because the endothermic peak temperature was 115.0° C., the effect of facilitating melting of the entire binder resin due to the polyester unit was insufficient.

The toner of Comparative Example 2 was rated as D for storage stability. Because the endothermic peak temperature was 50.0° C., the entire toner had considerably high mobility at room temperature.

The toner of Comparative Example 3 was rated as D for low-temperature fusibility. The endothermic peak temperature was 50.0° C. In addition, because the temperature difference (TgA−TgB) was 0.0° C., the polyester unit had high melt viscosity.

The toner of Comparative Example 4 was rated as D for low-temperature fusibility and storage stability and as C for durability. Because the binder resin was formed only of a polyester resin, a balance of low-temperature fusibility, storage stability, and durability was not provided.

The toner of Comparative Example 5 was rated as D for low-temperature fusibility. Because TgB was 52.0° C., the entire binder resin had low mobility when melted. Thus, the effect of facilitating melting of the entire binder resin due to the polyester unit was not provided.

The toner of Comparative Example 6 was rated as C for unevenness of fusing. Because the temperature difference (TgA−TgB) was −30.0° C., the binder resin had a considerably large difference in melt viscosity between the polyester resin and the vinyl polymer resin. In addition, because the polyester, including the melting portion, had high Tg, the polyester had a considerably large difference in melt viscosity within the polyester, which resulted in noticeable unevenness of fusing.

The toner of Comparative Example 7 was rated as D for low-temperature fusibility because the polyester unit in the hybrid resin contained no portion that melted at a particular temperature.

TABLE 4
Composition and properties of toner

| | Toner | | | Resin mixing ratio | Charge control | Magnetic iron | |
|---|---|---|---|---|---|---|---|
| | No. | Binder resin (1) | Binder resin (2) | (1)/(2) | agent | oxide particles | tanδ peak |
| Example 1 | 1 | Resin 1 | — | 100/— | T-77 | a | Not found |
| Example 2 | 2 | Resin 2 | — | 100/— | T-77 | a | Not found |
| Example 3 | 3 | Resin 3 | — | 100/— | T-77 | a | Not found |
| Example 4 | 4 | Resin 4 | — | 100/— | T-77 | a | Not found |
| Example 5 | 5 | Resin 5 | — | 100/— | T-77 | a | Not found |
| Example 6 | 6 | Resin 6 | — | 100/— | T-77 | a | Not found |
| Example 7 | 7 | Resin 7 | — | 100/— | T-77 | a | Not found |
| Example 8 | 8 | Resin 8 | — | 100/— | T-77 | a | Found |
| Example 9 | 9 | Resin 9 | — | 100/— | T-77 | a | Found |
| Example 10 | 10 | Resin 10 | — | 100/— | T-77 | a | Found |
| Comparative Example 1 | 11 | Resin 11 | — | 100/— | T-77 | a | Found |
| Comparative Example 2 | 12 | Resin 12 | — | 100/— | T-77 | a | Found |
| Comparative Example 3 | 13 | Resin 13 | — | 100/— | T-77 | a | Found |
| Comparative Example 4 | 14 | Resin 14 | — | 100/— | T-77 | a | Found |
| Comparative Example 5 | 15 | Resin 15 | — | 100/— | T-77 | a | Found |
| Comparative Example 6 | 16 | Resin 16 | Resin 17 | 70/30 | T-77 | a | Found |
| Comparative Example 7 | 17 | Resin 18 | — | 100/— | T-77 | a | Found |

TABLE 5
Evaluations

| | | | | | | Harsh- |
|---|---|---|---|---|---|---|
| | | Low- | | | | environment |
| | Storage | temperature | Unevenness | Material | | storage |
| | stability | fusibility | of fusing | dispersibility | Durability | stability |
| Example 1 | A | A | A(1) | A | A(0.03) | A(1) |
| Example 2 | A | A | B(4) | A | A(0.02) | A(1) |
| Example 3 | A | B | A(2) | A | A(0.05) | A(1) |
| Example 4 | A | B | A(0) | A | A(0.03) | A(2) |
| Example 5 | B | A | A(1) | A | A(0.04) | A(3) |
| Example 6 | B | B | A(1) | A | A(0.08) | A(4) |
| Example 7 | A | C | A(1) | A | A(0.02) | A(1) |
| Example 8 | A | C | A(1) | A | A(0.07) | B(6) |
| Example 9 | A | C | A(1) | A | B(0.15) | B(6) |
| Example 10 | A | C | A(1) | B | A(0.03) | B(6) |
| Comparative Example 1 | A | D | A(1) | A | B(0.18) | B(6) |
| Comparative Example 2 | D | C | A(1) | A | B(0.14) | B(8) |
| Comparative Example 3 | D | D | A(2) | B | A(0.05) | B(8) |
| Comparative Example 4 | D | D | A(2) | A | C(0.29) | B(9) |
| Comparative Example 5 | D | D | A(1) | A | B(0.12) | B(7) |
| Comparative Example 6 | D | D | C(7) | C | C(0.26) | C(14) |
| Comparative Example 7 | C | D | C(7) | B | C(0.22) | C(11) |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-241440 filed Nov. 2, 2011, which is hereby incorporated by reference herein in its entirety.

What is claimed is:

1. A toner comprising toner particles each of which contains a binder resin and a colorant,
wherein the binder resin is a hybrid resin in which a polyester unit and a vinyl polymer unit are chemically bound, and
wherein the hybrid resin satisfies the following:
(I) when the hybrid resin is dissolved in tetrahydrofuran at 25.0° C., tetrahydrofuran-soluble matter has a glass transition temperature TgB of from 30.0° C. to 50.0° C.; and
(II) when the hybrid resin is dissolved in cyclohexane at 25.0° C.,
(i) cyclohexane-soluble matter has a glass transition temperature TgA (° C.) higher than the glass transition temperature TgB, and
(ii) in differential scanning calorimetry, cyclohexane-insoluble matter shows a differential scanning calorimetry curve having an endothermic peak whose peak top falls within the range from 60.0° C. to 110.0° C.

2. The toner according to claim 1, wherein the polyester unit is formed by reacting a long-chain fatty acid having from 16 to 102 carbon atoms, a polycarboxylic acid, and a polyalcohol.

3. The toner according to claim 1, wherein the polyester unit is formed by reacting a long-chain alcohol having from 16 to 102 carbon atoms, a polyalcohol, and a polycarboxylic acid.

4. The toner according to claim 1, wherein in viscoelastometry, the toner has no loss tangent (tans) peak in the range from −50.0° C. to 10.0° C.
